(19) United States
(12) Patent Application Publication
(10) Pub. No.: US 2013/0215897 A1
(43) Pub. Date: Aug. 22, 2013

(54) MITIGATION OF DETECTED PATTERNS IN A NETWORK DEVICE

(71) Applicants: David Warren, El Dorado Hills, CA (US); Bruce E. LaVigne, Roseville, CA (US); Jonathan E. Greenlaw, Roseville, CA (US)

(72) Inventors: David Warren, El Dorado Hills, CA (US); Bruce E. LaVigne, Roseville, CA (US); Jonathan E. Greenlaw, Roseville, CA (US)

(21) Appl. No.: 13/809,064

(22) PCT Filed: Jul. 26, 2010
(86) PCT No.: PCT/US10/43265

§ 371 Date: Jan. 8, 2013

(51) Int. Cl. H04L 29/06

(52) U.S. Cl. CPC H04L 69/22
USPC 370/392

(57) ABSTRACT

A method for mitigating detected patterns in a network device is described herein. A packet is moved through a first pipeline of the network device, to perform processing of the packet. A pattern is detected within the packet. In response to detecting the pattern, a hardware component of the network device generates a flag as the packet is moving through the first pipeline, in parallel with the processing of the packet. One or more forwarding policies associated with the packet are determined using the flag.

### I. RELATED APPLICATIONS

The present application is related to co-pending International patent application number PCT/US2009/062899, entitled, Malicious Code Detection, filed on Oct. 31, 2009, the entire contents of which are incorporated herein by reference.

### II. BACKGROUND

With the rapid growth of computer network technology in general, network security has become a major concern. Malicious forms of computer code, such as computer viruses, Trojans, worms, etc., can spread from host computer to host computer by way of a network or other means. Malicious forms of computer code may be referred to as malicious code or malware. Malicious code may generally be considered as software that is designed to infiltrate a computing device without the informed consent of the owner or administrator of the device. Malware is a general term used to denote a variety of forms of hostile, intrusive, annoying, and/or unwanted software or program code. Antivirus software typically runs on a computer host so as to attempt to protect the computer host from becoming infected.

The identification of malicious code or malware, for example by antivirus software, is typically performed using signature-based techniques. Typical solutions are inefficient in how security-related data is detected (e.g., using signatures or other types of pattern information) and subsequently handled.

### III. BRIEF DESCRIPTION OF THE DRAWINGS

The present disclosure may be better understood and its numerous features and advantages made apparent to those skilled in the art by referencing the accompanying drawings.

FIG. 1 is a block diagram of a device for mitigation of detected patterns in accordance with an embodiment of the invention.

FIG. 2 is a topological block diagram of a backplane fabric and nodes of a network device in accordance with an embodiment of the invention.

FIG, 3 is a process flow diagram for mitigation of detected patterns in accordance with an embodiment of the invention.

### IV. DETAILED DESCRIPTION OF THE INVENTION

Network administrators and users of host devices connected to a network are often concerned with detecting occurrences of security-related data, such as malicious code or key words in an email, at the points of entry/exit of their networks to the outside world (e.g., the Internet), in addition to or in lieu of trying to detect malicious code individually at each computing device within the organizations. This detection is important throughout the network infrastructure, as connection points to the network are now increasingly varied due to the advent of wireless and virtualization technologies.

After detection, mitigation may be performed to address the detected condition. Existing techniques suffer from some disadvantages, however. In one approach, a notification may be sent indicating the detection of a virus signature. For example, an interrupt may be sent to a central processing unit (CPU) such as an on-chip embedded CPU or an off-chip CPU. By the time the CPU receives the interrupt, the packet which was detected as including the virus signature has long since exited the network device. As such, the network device is unable to prevent the packet from exiting in a valid form.

A method for mitigating detected patterns in a network device is described herein. A packet is moved through a first pipeline of the network device, to perform processing of the packet. Prior to this processing pipeline, initial forwarding and policy actions, which are well understood, may be performed on the packets. A pattern is detected within the packet. In response to detecting the pattern, a hardware component of the network device generates a flag as the packet is moving through the first pipeline, in parallel with the processing of the packet. One or more forwarding policies associated with the packet are determined using the flag.

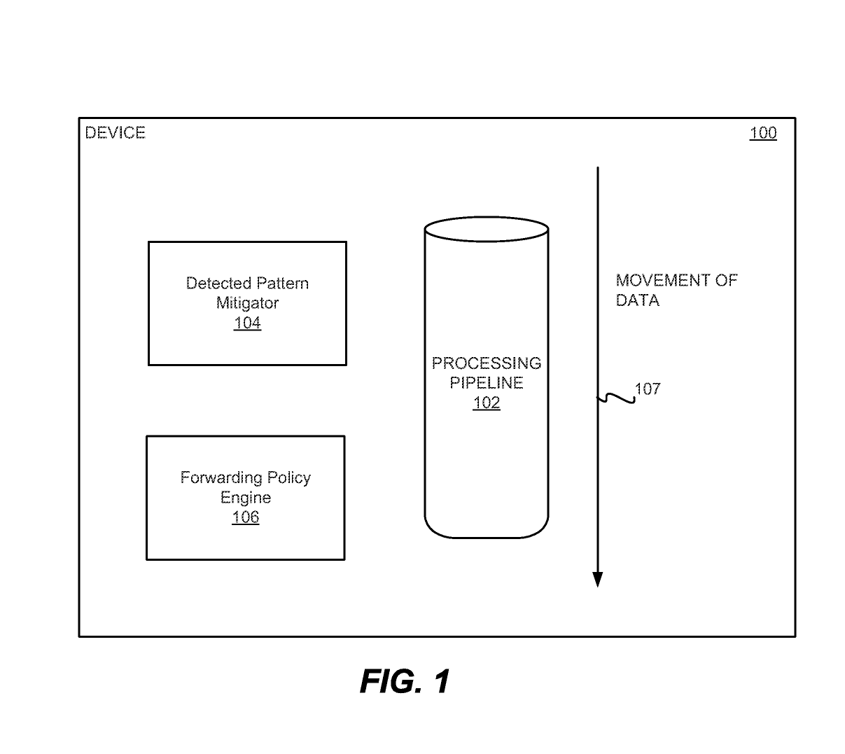

FIG. 1 is a block diagram of a device 100 for mitigation of detected patterns in accordance with an embodiment of the invention. Device 100 may be a switch, router, or other type of networking device. Alternatively or additionally, device 100 may be a computing device, such as a server computing device, host computing device, client computing device, among other types of computing devices.

Device 100 includes a processing pipeline 102, a detected pattern mitigator 104, and a forwarding policy engine 106. Both pipeline 102 and mitigator 104 are implemented at least in hardware. In one embodiment, pipeline 102 and mitigator 104 are implemented solely in hardware, such as by using appropriate application-specific integrated circuits (ASICs), field-programmable gate arrays (FPGAs), and other types of hardware components. In another embodiment, pipeline 102 and mitigator 104 may be implemented by a combination of hardware and software that is executed by a processor to perform their respective functions.

To process data within device 100, the data is moved through pipeline 102, as indicated by arrow 107. This processing is unrelated to the mitigation of any detected patterns in the data. That is, the purpose of moving the data through pipeline 102 to perform processing on the data is unrelated to the mitigation of any detected patterns in the data. The processing is performed on the data as it is moved through pipeline 102.

For example, where device 100 is a network device, the data may be incoming data packets received from outside a network to which the network device is a member. As used herein, a network device is a switch, router, or other network device. Device 100 may be configured to forward data in a network.

One or more processing pipelines, such as pipeline 102, are configured to process data packets. For example, as a part of a forwarding operation, the data packets may be processed by being classified, queued, modified, routed from an ingress port to a correct egress port, transmitted, dropped, etc. In one embodiment, each data packet received via an ingress port of device 100 flows through at least one pipeline, such as pipeline 102. Each stage of pipeline 102 performs a part of the processing of the data packet.

Mitigator 104 is configured to generate a flag for those data packets which have been detected as including a particular pattern of interest. A pattern may be a signature of a virus, an alphanumeric sequence, or any other pattern of interest. In one embodiment, the flagging operation is performed in parallel with the processing of the data as the data is moved through pipeline 102, without delaying the movement of the data into, through, and out of pipeline 102. The data processing that is performed in pipeline 102 is independent of the flagging performed by mitigator 104. Data enters, moves through, and exits pipeline 102 in the typical course of action without waiting for mitigator 104 to perform its function. In other words, mitigator 104 is configured to generate a flag for the detected data packets at line rate. As such, device 100 is able to prevent the packet from exiting device 100 in a valid form.

Forwarding policy engine 106 is configured to determine one or more policies associated with the data packets that have detected patterns. The flag may be used to determine what mitigation should be performed. The policies may be fully configurable, programmable, and modifiable. In one embodiment, one or more processing pipelines, such as pipeline 102, are configured to process the data packets that have detected patterns in accordance with the one or more associated policies as determined by forwarding policy engine 106.

In this respect, the embodiment of FIG. 1 is able to mitigate detected patterns in the data packets without reducing the overall performance of a device such as device 100. Furthermore, the embodiment of FIG. 1 does not require potentially expensive dedicated processors for mitigation of detected patterns. Rather, mitigator 104 and forwarding policy engine 106 may be implemented in hardware via lower cost hardware components. Moreover, in at least some situations all data that enters device 100 is moved through pipeline 102 for processing such that the detected data is flagged prior to exiting device 100. Additionally, the tagged data may be processed according to one or more forwarding policies prior to exiting device 100.

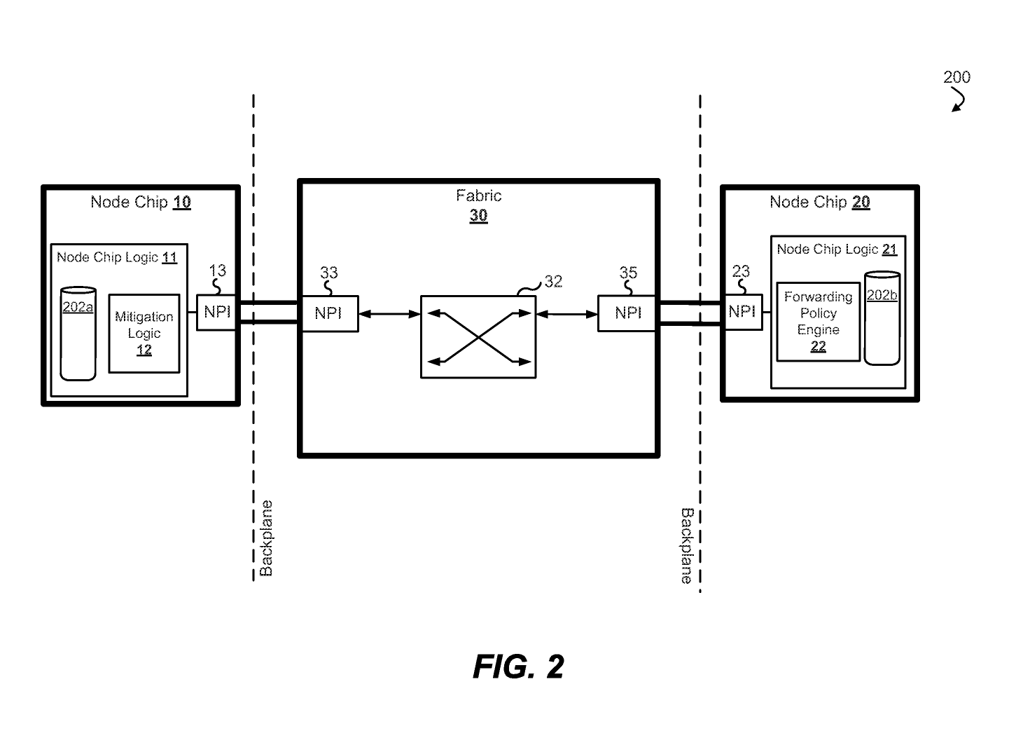

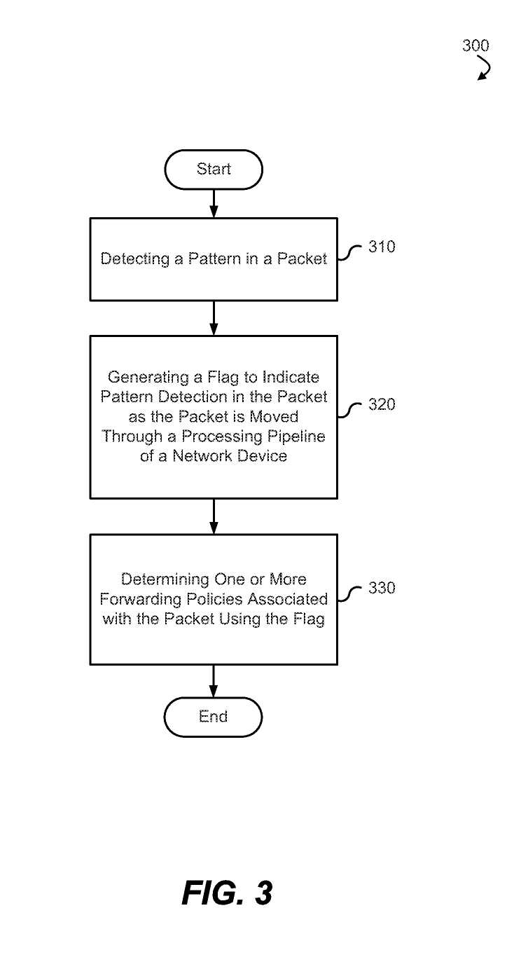

FIG. 2 is a topological block diagram of a backplane fabric and nodes of a network device 200 in accordance with an embodiment of the invention. A conventional network device, such as a switch or router, includes three major components: a control processor, a line card, and a switch fabric. The conventional control processor implements various control and administrative functions, such as executing routing protocols.

The line cards include node chips and generally terminate physical links on the network device and implement the specific protocol processing functions that define a particular network. At an ingress node, a processing function may include normal forwarding policies, such as determining a next device in the network to which the packet should be sent, and/or generating a tag for packets that have been detected as including a pattern of interest. At an egress node, a processing function may include scheduling the packet for transmission on an outgoing link and/or determining one or more forwarding policies associated with the packets using the flag and forwarding the packets according to the associated policies.

The switch fabric is responsible for transferring packets from the nodes (e.g., line cards) from which the packet was received to the nodes (e.g., line cards) for the outgoing link connected to the next device in the network. For example, after a forwarding decision is made, a packet is sent to the switch fabric, which then sends the packet to a line card for the outgoing link. The packet is transmitted through the outgoing link to the next-hop device.

A backplane fabric and nodes of system 200 are generally configured to switch packets from an ingress node to an egress node. System 200 includes a node chip 10, a node chip 20, and a fabric 30. As used herein, a packet includes data that moves between different nodes across the fabric where the ingress node and egress node are different, or within the same node where the ingress node and egress node are one in the same. This includes network data packets, portions thereof, node to node control messages that manage the transfer of network data packets or portions thereof, etc. In one embodiment, the fabric may be a fabric chip. In another embodiment, the fabric may be a broadcast fabric.

Node chip 10 may be on a line card of the network switch. Node chip 10 is operatively coupled to fabric 30 via node physical interface (NPI) 13. An NPI is configured to transmit and receive packets and link control messages across a communication link. As used herein, each NPI may have a pair of channels, such as a transmit (Tx) channel and a receive (Rx) channel. Each channel may have any number of serializer/deserializer (SerDes) lanes, for example, two SerDes per NPI. In one embodiment, there may be as many as 18 NPIs.

NPI 13 is operatively coupled to node chip logic 11 and to fabric 30. Node chip logic 11 is operatively coupled to NPI 13 of node chip 10. Node chip logic 11 includes a first processing pipeline 202a and mitigation logic 12. Pipeline 202a is configured to process data packets. Mitigation logic 12 is configured to generate a flag for data packets which have been detected as including a particular pattern of interest, such as a signature of a virus, an alphanumeric sequence, etc. In one embodiment, flag generation is performed in parallel with the processing of the data as it is moved through pipeline 202a.

Node chip 20 may be on a line card of the network switch. Node chip 20 is operatively coupled to fabric 30 via NPI 23. NPI 23 is operatively coupled to node chip logic 21 and to fabric 30.

Node chip logic 21 is operatively coupled to NPI 23 of node chip 20. Node chip logic 21 includes a second processing pipeline 202b and forwarding policy engine 22. Forwarding policy engine 22 is configured to determine one or more policies associated with data packets that have detected patterns. Pipeline 202b is configured to process these data packets in accordance with the one or more associated policies as determined by forwarding policy engine 22. In one embodiment, the associated policies are enforced in parallel with the standard processing of the data as it is moved through pipeline 202b.

It is recognized that a packet may enter and exit on a same node chip, i.e., the node chip through which the packet was received is one and the same as the node chip for the outgoing link. In one embodiment, traffic that enters and exits on the same node chip travels over the fabric. In another embodiment, traffic that enters and exists on the same node chip is handled by that node chip and does not travel over the fabric, but still passes through pipeline 102.

Fabric 30 is operatively coupled to node chip 10 and node chip 20. Fabric 30 includes a plurality of NPIs, such as NPIs 33-35, and a switch fabric 32. Switch fabric 32 may be a non-blocking fabric, such as a buffered crossbar, and include a plurality of fabric ingress ports and a plurality of fabric egress ports at opposite ends of dynamically switched data paths. Switch fabric 32 is configured to forward packets from a fabric ingress port to a fabric egress port of switch fabric 32.

NPIs 33-35 are configured to transmit and receive packets across a communication link. Each NPI may have a pair of channels, such as a transmit (Tx) channel and a receive (Rx) channel. Each channel may have any number of serializer/deserializer (SerDes) lanes, for example, two SerDes per NPI. In one embodiment, there may be as many as 18 NPIs.

A single fabric 30 is shown as being operatively coupled to node chip 10 and node chip 20. In other embodiments, a plurality of fabrics may be used.

In operation, a packet may be received on ingress by node chip 10 for processing. In one embodiment, a pattern may be detected in the packet as the packet flows through pipeline 202a. In other embodiments, pattern detection may occur before the packet is placed in pipeline 202a.

Mitigation logic 12 may generate a flag or otherwise modify the packet, generate and provide a message or signal, or provide another indication that a pattern detection occurred, as the packet travels through pipeline 202a. When the detected packet exits pipeline 202a, it has been duly flagged. The flag and/or message may be provided to fabric 30 for routing to the proper egress node chip, such as node chip 20. The packet may be received on egress by node chip logic 21, where node chip 20 is the proper egress node for the packet. Node chip logic 21 may detect the packet as being flagged (e.g., detect the flag). Detection of the flag may trigger further action, for example by forwarding engine 22. As the packet flows through pipeline 202b, forwarding policy engine 22 may determine the forwarding policies associated with the packet. These associated policies may be applied to the packet as it exits network device 200.

The present invention may be applied in various network topologies and environments. Backplane fabric and nodes as described herein may be incorporated into any type of network familiar to those skilled in the art that can support data communications using any of a variety of commercially-available protocols.

FIG. 3 is a process flow diagram for mitigation of detected patterns in accordance with an embodiment of the invention. The depicted process flow 300 may be carried out by execution of one or more sequences of executable instructions. In another embodiment, the process flow 300 is carried out by execution of components of a network device, an arrangement of hardware logic, e.g., an Application-Specific Integrated Circuit (ASIC), etc.

In a system for on-chip communication between an ingress node and an egress node of a network device, packets may be processed by the ingress node and the egress node through one or more processing pipelines. At the ingress node, data from the packet and attributes of that packet flow through various stages of a processing pipeline. Each stage in the pipeline consumes a set number of clock cycles and the packets are processed in order. In one embodiment, the packet is parsed, table lookups are performed, a decision routing process is performed, etc. One stage may include modifying the packet before exiting the processing pipeline.

At step 310, a pattern may be detected in a packet. For example, as the packet flows through the processing pipeline, a pattern detector uses correlators to examine the bits of the packet. The correlators may be implemented as hardware components which detect the presence of a pattern, such as a malicious code signature or a sequence of alphanumeric characters, in the packet. Embodiments of the present invention may be used in combination with the pattern detection methodologies disclosed in commonly-assigned and co-pending International patent application number PCT/US2009/062899, filed on Oct. 31, 2009, the entire contents of which are incorporated herein by reference. Other methodologies of pattern detection may also be employed.

In one embodiment, a packet received by the ingress node is converted into multiple mini-packets. As used herein, a mini-packet is smaller in size than the packet and includes a header and a payload. The pattern may be detected in one or more of these mini-packets, or it may span mini-packets.

At step 320, a flag is generated to indicate pattern detection in the packet. The flag may be generated as the packet flows through a processing pipeline of a network device. Generation of the flag may be accomplished in various manners. In one embodiment, one or more bits in the header of the detected packet are asserted. The packet may include a one bit reserved field which is normally set to zero. The reserved field bit may be asserted to indicate the pattern detection.

In another embodiment, the flag includes multiple bits, which may be used to identify which pattern was detected. By doing so, a central server, or other device which performs subsequent processing of the packet after it has exited the network device, may be relieved from analyzing the packet to decipher which pattern was detected. The central server may be overwhelmed where high volumes of traffic with detected patterns are present, and as such, offloading this portion of the packet analysis may greatly improve performance of the central server during subsequent packet processing. In yet another embodiment, the packet may be corrupted by overwriting all or a portion of the packet with zeros or inverting existing data bits. For example, the bits corresponding to the detected pattern may be overwritten by zeros, or the CRC may be corrupted by inverting some or all bits.

Furthermore, the flag may be a message, which is provided to the egress node. For example, sideband signals or other messages may be sent to the egress node indicating that the packet includes detected patterns. In another embodiment, the messages or signals may indicate merely that the packet warrants further analysis. In one embodiment, pattern detection and flag generation may occur at an ingress node, at a fabric, and/or an egress node of the network device.

At step 330, one or more forwarding policies associated with the packet are determined using the flag. In one embodiment, the packet is received by a processing pipeline of an egress node, for example, from a fabric, for normal processing. Headers of packets in the pipeline of the egress node may be examined by the egress node. The flag may be detected, for example by reading the header and learning that the packet is a packet that has a detected pattern.

Detecting the flag may also be accomplished by receiving sideband signals or messages that indicate the packet includes detected patterns or otherwise warrants further analysis.

As the packet moves through the pipeline of the egress node, one or more forwarding policies associated with the packet are determined using the flag. For example, the detection of the flag triggers further action. In addition to typical routing policies (e.g., forwarding the packet to a next-hop network device), the forwarding policies may be designed to effectuate various internal mitigation schemes of such packets (i.e., packets with detected patterns) while using line rate detection. Processing resources are minimized by limiting the subsequent analysis to packets with detected patterns, rather than randomly analyzing all packets.

For example, the forwarding policy may specify re-routing, or mirroring by forwarding a duplicate packet to a mitigation handling location such as an onboard central processing unit (CPU) in an ASIC, or a dedicated external processor. Additionally, the forwarding policy may specify tunneling the packet to a remote location dedicated to handling packets with issues, such as a security agency. Moreover, the forwarding policy may specify various reporting actions to be taken, for example by sending alerts, log information (e.g., Syslog data), and/or packet sampling information (e.g., sFlow, Netflow, etc.) to a network administrator and/or to a central collection device for further analysis. In another embodiment, other logic (hardcoded or otherwise) may take further action on the packet upon detection of the associated flag.

Where the packet is made up of multiple mini-packets, flags may be generated for one or more of the mini-packets as previously described. For example, a flag may be placed in the header of the mini-packet before it exits the ingress node. The mini-packet may be received in a processing pipeline of the egress node. One typical stage in the processing pipeline may include reassembly of the original packet, which may include collecting the mini-packets that were created from the original packet. The egress node may detect or otherwise recognize flags in mini-packets. Where flags have been generated for one or more mini-packets of the original packet, the entire reassembled packet may be identified as including detected patterns or otherwise warranting further analysis. Forwarding policies associated with the reassembled packet may be determined.

It will be appreciated that embodiments of the present invention can be realized in the form of hardware, software, firmware, or any combination thereof. Any such software may be stored in a computer system including a processor and a storage in the form of volatile or non-volatile storage, such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. The storage may be located outside of a node chip of a computer system such as a network device and may be operatively connected to a processor of the node chip. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A mitigation method, comprising:
moving a packet through a first pipeline of a network device, to perform processing of the packet;
detecting a pattern within the packet;
in response to detecting the pattern, generating, by a hardware component of the network device, a flag as the packet is moving through the first pipeline, in parallel with the processing of the packet; and
determining one or more forwarding policies associated with the packet using the flag.

2. The method of claim 1, wherein generating the flag comprises asserting one or more bits in a header of the packet.

3. The method of claim 2, wherein the one or more bits in the header identify the detected pattern.

4. The method of claim 1, wherein generating the flag comprises providing to an egress node a message indicating detection of the pattern within the packet.

5. The method of claim 3, wherein the flag is generated by an ingress node of the network device.

6. The method of claim 1 further comprising, prior to determining the one or more forwarding policies:
moving the packet through a second pipeline of the network device; and
detecting the flag as the packet is moving through the second pipeline.

7. The method of claim 6, wherein the one or more forwarding policies specify at least one of mirroring the packet to a mitigation handling location, re-routing the packet to the mitigation handling location, tunneling the packet to a remote location, and reporting information about the packet to a central collection device for further analysis.

8. The method of claim 6, wherein the flag is detected by an egress node of the network device.

9. A network device for mitigating detected patterns, the device comprising:
a first pipeline implemented at least in hardware, through which a plurality of packets are moved to perform processing of the packets;
a mitigator coupled to the first pipeline, wherein the mitigator is configured to generate a flag associated with a packet of the plurality of packets as the packet is moving through the first pipeline, in parallel with the processing of the packet, wherein the packet includes a detected pattern; and
a forwarding policy engine configured to determine one or more forwarding policies associated with the packet using the flag.

10. The network device of claim 9, wherein generating the flag comprises asserting one or more bits in a header of the packet.

11. The network device of claim 9, further comprising:
a second pipeline implemented at least in hardware, through which the plurality of packets are moved to perform processing of the packets, wherein the second pipeline is coupled to the forwarding policy engine, and wherein the associated forwarding policies are determined in parallel with the processing of the packet in the second pipeline.

12. The network device of claim 11, wherein the one or more forwarding policies specify at least one of mirroring the packet to a mitigation handling location, re-routing the packet to the mitigation handling location, tunneling the packet to a remote location, and reporting information about the packet to a central collection device for further analysis.

13. A network device comprising:
an ingress node comprising:
a first pipeline implemented at least in hardware, through which a plurality of packets are moved to perform processing of the packets; and
a mitigator coupled to the first pipeline, wherein the mitigator is configured to generate a flag associated with a packet of the plurality of packets as the packet is moving through the first pipeline, in parallel with the processing of the packet, wherein the packet includes a detected pattern;
an egress node comprising:
a second pipeline implemented at least in hardware, through which the plurality of packets are moved to perform processing of the packets; and
a forwarding policy engine coupled to the second pipeline, wherein the forwarding policy engine is configured to determine one or more forwarding policies associated with the packet using the flag; and
a fabric coupling the ingress node to the egress node for transmission of packets from the first pipeline of the ingress node to the second pipeline of the egress node.

14. The device of claim 13, wherein generating the flag comprises asserting one or more bits in a header of the packet.

15. The device of claim 13, wherein the one or more forwarding policies specify at least one of mirroring the packet to a mitigation handling location, re-routing the packet to the mitigation handling location, tunneling the packet to a remote location, and reporting information about the packet to a central collection device for further analysis.
